(19) United States
(12) Patent Application Publication
(10) Pub. No.: US 2022/0323913 A1
(43) Pub. Date: Oct. 13, 2022

(54) Method for Fabricating Mixed-Matrix Membranes and Methods of Use

(71) Applicants: Hae-Kwon Jeong, College Station, TX (US); Yinying Hua, College Station, TX (US); Sung-Hwan Park, College Station, TX (US)

(72) Inventors: Hae-Kwon Jeong, College Station, TX (US); Yinying Hua, College Station, TX (US); Sung-Hwan Park, College Station, TX (US)

(73) Assignee: Texas A&M University, College Station, TX (US)

(21) Appl. No.: 17/719,143

(22) Filed: Apr. 12, 2022

Related U.S. Application Data
(60) Provisional application No. 63/173,787, filed on Apr. 12, 2021.

(51) Int. Cl. B01D 69/14; B01D 71/02; B01D 71/64; B01D 69/12; B01D 67/00

(52) U.S. Cl. CPC B01D 69/148; B01D 71/028; B01D 71/64; B01D 69/125; B01D 67/0079; B01D 2323/21; B01D 2325/022

(57) ABSTRACT

Provided herein are one-step methods for fabricating an asymmetric mixed-matrix membrane and the asymmetric mixed matrix membrane so fabricated. In the one step method an asymmetric polymer film is formed from a liquid polymer solution and a ligand precursor simultaneously with the formation of metal-organic framework filler particles therein. Also provided is a method for separating a mixture of gases or of liquids by flowing the mixture through the asymmetric mixed matrix membrane.

### CROSS-REFERENCE TO RELATED APPLICATIONS

This non-provisional patent application claims benefit of priority under 35 U.S.C. § 119(e) of provisional application U.S. Ser. No. 63/173,787, filed Apr. 12, 2021, the entirety of which is hereby incorporated by reference.

### FEDERAL FUNDING LEGEND

This invention was made with government support under Grant Number CBET-1929596 and Grant Number DBI-0116835 awarded by the National Science Foundation. The government has certain rights in the invention.

### BACKGROUND OF THE INVENTION

### Field of the Invention

The present invention relates to the fields of metal-organic framework formation (MOF), mixed-matrix membrane (MMM) fabrication and membrane-based gas and liquid separation. More particularly, the present invention relates to a one step method for the scalable formation of high-performance asymmetric MMMs for membrane-based gas separation.

### Description of the Related Art

Membrane-based gas separation is an attractive energy-efficient alternative to the conventional thermally-driven technologies (1, 2). Several polymer membranes have successfully been applied for the commercial separations of light gases (3). The separation performances of the polymer membranes are, however, limited by a trade-off between permeability and selectivity (4), thereby hindering their applications for rapidly growing diverse gas separation markets such as olefin/paraffin separations (3, 5). While current MMMs have shown improved gas separation performances compared to their polymer counterparts, the commercial applications of the MMMs have been substantially hampered by several engineering and scientific challenges (6-8). There have been tremendous efforts to address the scientific challenges including poor filler-polymer interfacial interactions and filler agglomeration (9). On the other hand, much less attention has been given to the engineering challenges for economically manufacturing defect-free MMMs in a scalable geometry (i.e., asymmetric microstructures with thin selective mixed-matrix layers) (6). The engineering challenges result mostly from the conventional physical blending based MMM processing, which turns out extremely difficult to rapidly prepare asymmetric membranes with thin selective mixed-matrix layers. It is, therefore, highly desirable to develop a fundamentally new MMM fabrication strategy that can overcome both of the scientific and engineering challenges.

In-situ MMM fabrication is an emerging strategy that might potentially overcome the limitations of the conventional blending methods. Marti et al. (10) demonstrated a simple one-step fabrication of Matrimid®/UiO-66 MMMs using in-situ filler formation in a polymer solution containing UiO-66 precursors. Despite facile MMM formation, the membranes showed limited filler loadings due to the particle agglomeration, exhibiting not much improvement in their gas separation performances as compared to those conventionally prepared (10). Recently, a novel scalable in-situ MMM fabrication strategy, termed as polymer-modification-enabled metal-organic framework formation (PMMOF) (11) was reported. The PMMOF decouples filler incorporation from membrane formation by in-situ forming MOF fillers in preformed polymer films, thereby enabling the transformation of polymer membranes to MMMs (11). Using the PMMOF, the first MMM modules were made of ZIF-8-containing asymmetric MMM hollow fibers (12). Although the PMMOF process effectively suppressed the issues of conventional blending-based MMMs, the process involves multiple steps, likely adding the manufacturing cost. More importantly, the PMMOF can be applied only to polyimide-based polymers, compromising its versatility.

Thus, there is a need in the art for new methods of preparing high-performance mixed-matrix membranes. The prior art is deficient in a one-step scalable in-situ asymmetric MMM fabrication process. Particularly, the prior art is deficient in an in-situ fabrication process that synchronizes metal-organic framework (MOF) formation with polymer phase-inversion. The present invention fulfills this long-standing need and desire in the art.

### SUMMARY OF THE INVENTION

The present invention is directed to a one-step method for fabricating an asymmetric mixed-matrix membrane. In the method an asymmetric polymer film is formed simultaneously with forming metal organic framework (MOF) filler particles therein.

The present invention also is directed to an asymmetric mixed-matrix membrane fabricated by the method described herein.

The present invention is directed further to a method for separating a mixture of gases or of liquids comprising flowing the mixture through the asymmetric mixed-matrix membrane described herein

The present invention is directed further still to an asymmetric mixed-matrix membrane fabrication process. The fabrication process comprises a single step of transforming, via phase inversion at room temperature to about 40° C., a metal precursor containing liquid polyimide solution into which an imidazole diffuses during solidification of the polyimide solution to an asymmetric polymer film simultaneously as the metal precursor reacts in situ with the imidazole to form metal-imidazolate framework filler particles therein.

These and other features, aspects, and advantages of the embodiments of the present disclosure will become better understood when the following detailed description is read with reference to the accompanying drawings.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIGS. 1A-1C are schematic illustrations of the facile formation of an asymmetric MMM by the PIMOF process. The steps are casting a polymer solution containing zinc ions on a porous polymer support (FIG. 1A), phase inversion by immersion precipitation in a coagulation bath involving 2-methylimidazole (Hmlm) ligands concurring with the in-situ formation of ZIF-8 particles inside the polymer (FIG. 1B) and slow drying (FIG. 1C).

FIGS. 2A-2D are a ternary phase diagram and cross-sectional and top view SEM images of a polymer membrane and mixed-matrix membranes prepared by the PIMOF. FIG. 2A is a ternary phase diagram of zinc-containing polymer solutions. Arrows in the diagram indicate hypothetical evolutions of the top skin (red arrow) and the bottom porous (yellow arrow) layers of a single-phase solution upon phase inversion by immersion precipitation. FIGS. 2B-2D are cross-sectional and top view SEM images of a 6FDA-DAM polymer membrane (FIG. 2B) and 6FDA-DAM/ZIF-8 PIMOF MMMs made under various coagulation conditions: 2.0 M Hmlm at RT (FIG. 2C), and 2.0 M Hmlm at 40° C. (FIG. 2D). The arrows in (FIGS. 2B-2D) indicate the apparent skin layers. The 6FDA-DAM membrane was prepared using the same polymer solution in a coagulation bath at RT without Hmlm.

FIGS. 3A-3D are SEM images of the PIMOF MMMs prepared in the coagulation bath with different linker concentrations.

FIGS. 4A-4D are SEM images of the PIMOF MMMs prepared in the coagulation bath containing 2.0 M Hmlm at 60° C.

FIGS. 5A-5H are XRD patterns and TEM images. FIG. 5A shows XRD patterns of MMMs with different ligand concentrations in the coagulation bath in comparison with that of a MMM prepared by a conventional blending method. The numbers in the parentheses are the ligand concentrations in the coagulation bath and 0.0 M represents a pure 6FDA-DAM membrane. The coagulation bath temperature was at RT. FIG. 5B is a TEM image of the cross-section of the PIMOF MMM (2.0 M, 40° C.). FIG. 5C is a Zn EDS elemental mapping image of the same sample as shown in FIG. 5B. FIG. 5D is a STEM image and FIG. 5E is a TEM image of the intermediate skin layer. FIG. 5F is an HRTEM image of the ZIF-8 particles in the intermediate layer and the corresponding FFT pattern in the inset (FIG. 5G). FIG. 5H shows the overall structure of the PIMOF MMM.

FIGS. 6A-6G are photographs of the phase inversion at the coagulation bath with the Hmlm concentration of 2 M at RT at 0 sec (FIG. 6A), 5 sec (FIG. 6B), 30 sec (FIG. 6C), 60 sec (FIG. 6D), 5 min (FIG. 6E), 30 min (FIG. 6F), and 60 min (FIG. 6G).

FIG. 7 is a TGA thermogram of samples under air flow.

FIG. 8A-8F show SEM-EDS mapping PIMOF MMM (2 M, RT) (FIG. 8A) and cross-sections of zinc (FIGS. 8B, 8D), fluorine (FIGS. 8C, 8F) and carbon (FIG. 8E).

FIG. 9 shows total ZIF-8 loadings and loadings in the skin layer only. Total loadings are determined from TGA analysis and the skin layer loadings are from TGA and EDS analysis.

FIGS. 10A-10C are a TEM image of the cross section of the PIMOF MMM (2 M, 40° C.) (FIG. 10A), a STEM image of the magnified porous layer (FIG. 10B) and a Zn EDS elemental map of the STEM image (FIG. 10C).

FIGS. 11A-11B are N₂ adsorption isotherms at 77 K of a PIMOF MMM (2 M, RT) in comparison with those of ZIF-8 and a conventionally prepared MMM with 20 wt % ZIF-8 loading in a linear-log scale (FIG. 11A) and a log-log scale (FIG. 11B).

FIGS. 12A-12C illustrate C3 separation performances. FIG. 12A shows the C3 separation performances of the PIMOF MMMs in comparison with other membranes. All PIMOF MMMs presented here are made on PP supports except one on PTFE (ADVANTEC MFS, 102968-892) supports. FIG. 12B shows the time-dependent C3 separation performance of the PIMOF MMMs (2 M, RT). FIG. 12C shows the C3 separation performance of the PIMOF MMMs (2 M) at the different coagulation bath temperatures.

### DETAILED DESCRIPTION OF THE INVENTION

The articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”. “Including” and “including but not limited to” are used interchangeably.

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure. For example, about 50 wt % encompasses 45 wt % to 55 wt % and about 40° C. encompasses 36° C. to about 44° C.

As used herein, the term “room temperature” refers to a temperature of about 20° C. to about 26° C.

In one embodiment of this invention, there is provided a one-step method for fabricating an asymmetric mixed-matrix membrane, comprising forming an asymmetric polymer film simultaneously with forming metal organic framework (MOF) filler particles therein.

In an aspect of this embodiment forming the asymmetric polymer film may comprise transforming a liquid polymer solution containing a metal precursor in the presence of a ligand precursor to a solid polymer film with an asymmetric structure via phase inversion. In this aspect forming the MOF filler particles may comprise diffusing the ligand precursor into the polymer solution as it solidifies to react in situ with the metal precursor to form the MOF filler particles therein. Particularly, forming the MOF filler particles may occur at room temperature to less than 100° C.

In this aspect the polymer in the liquid polymer solution may be a polyimide polymer. Also, the metal precursor may be a nitrate, acetate, nitride, or sulfate of the metal or a chloride salt solution of zinc, cobalt, magnesium, manganese, iron, nickel, copper, zirconium, or cadmium, or a combination thereof. In addition the ligand precursor may be an organic linker. Particularly, the organic linker may be imidazole, 2-methyl imidazole, 2-ethylimidazole, 2-nitroimidazole, benzimidazole, 6-nitrobenzimidazole, 1-hexyl-3-methylimidazolium or purine or a combination thereof. Furthermore, the MOF filler particles may be zeolitic-imidazolate-framework filler particles.

In another embodiment of the present invention there is provided an asymmetric mixed-matrix membrane fabricated by the method as described supra. In an aspect of this embodiment an asymmetric polymer film may be formed with a skin layer on top of a bottom porous layer and a plurality of zeolitic-imidazolate-framework (ZIF) filler particles dispersed within the polymer film. Particularly, the skin layer may comprise a plurality of intermediate layers with a majority of the plurality of the zeolitic-imidazolate-framework filler particles dispersed therein. In this aspect the majority of the zeolitic-imidazolate-framework filler particles may comprise about 50 wt % of the skin layer. Also in this aspect the zeolitic-imidazolate-framework filler particles may be less than 5 nm to about 10 nm in size. In this embodiment and aspects thereof the asymmetric mixed-matrix membrane may be a 6FDA-DAM/ZIF-8 asymmetric mixed-matrix membrane.

In yet another embodiment of the present invention there is provided a method for separating a mixture of gases or of liquids comprising flowing the mixture through the asymmetric mixed-matrix membrane, as described supra. In one aspect of this embodiment the mixture of gases may be a binary gas mixture. Particularly, the binary gas mixture may be a propylene/propane gas mixture. In another aspect of this embodiment the mixture of liquids may be a mixture of organic liquids or a mixture of at least one organic liquid and water.

In yet another embodiment of the present invention there is provided an asymmetric mixed-matrix membrane fabrication process, comprising transforming, via phase inversion at room temperature to about 40° C., a metal precursor containing liquid polyimide solution into which an imidazole diffuses during solidification of the polyimide solution to an asymmetric polymer film simultaneously as the metal precursor reacts in situ with the imidazole to form metal-imidazolate framework filler particles therein. In this embodiment the metal precursor may be a zinc nitrate. Also in this embodiment the method 6FDA-DAM/ZIF-8 asymmetric mixed-matrix membrane may be fabricated.

The present invention provides a one-step method to fabricate asymmetric polymer membranes and films, such as asymmetric mixed-matrix membrane, and the mixed-matrix membranes fabricated thereby. The one-step method is scalable. The method is a phase-inversion in sync with metal-organic framework formation (PIMOF) process. The key to the one-step method is the simultaneity of dry-jet/wet-quenching induced polymer phase inversion and in-situ synthesis of metal-organic framework (MOF) crystals. Generally, a casted polymer solution containing a metal precursor is immersed in a coagulation bath containing a ligand precursor whereby diffusion of the metal precursor and the ligand precursor form metal-organic framework particles within the polymer. A non-limiting example of an asymmetric mixed-matrix membrane is a 6FDA-DAM/ZIF-8 mixed matrix membrane.

In the in-situ nucleation and growth of the MOF particle fillers occurs instantly by rapid reactions. Moreover, increasing the ligand precursor concentration in the coagulation bath increases the performance of the asymmetric polymer membranes and films. Correspondingly, increasing the temperature of the coagulation bath results in a thinner separation layer due to higher phase inversion rate. The temperature of the coagulation bath may be room temperature to less than 100° C., particularly, about 40° C. to less than 60° C.

The polymer may be any polymer, for example, a polyimide polymer. Non-limiting examples of a polymer are (4,4-(Hexafluoroisopropylidene)diphthalic anhydride-2,4,6-trimethyl-1,3-phenylene diamine (6FDA-DAM), pyromellitic dianhydrides oxidianiline (PMDA-ODA), 3,3-4,4-benzophenone tetracarboxylic dianhydride diaminophenylindane (BTDA-DAPI). Representative examples of the metal precursor are, but are not limited to, nitrates, acetates, nitrides, sulfates or chloride salt solutions of zinc, cobalt, magnesium, manganese, iron, nickel, copper, zirconium, or cadmium, or a combination thereof. The ligand precursor may be any organic ligand useful in a metal organic framework ligands. The organic ligand may be an imidazolate-based ligand. Representative examples of the ligand precursor are, but are not limited to, imidazole, 2-methyl imidazole, 2-ethylimidazole, 2-nitroimidazole, benzimidazole, 6-nitrobenzimidazole, 1-hexyl-3-methylimidazolium or purine, or a combination thereof.

The MOF particle fillers may be nanoparticles. The MOF particle fillers may be zeolitic-imidazolate-framework particles. The zeolitic-imidazolate-framework is, but is not limited to, a mixed-metal zeolitic-imidazolate-framework, a mixed-linker zeolitic-imidazolate-framework, or a mixed-metal/mixed-linker zeolitic-imidazolate-framework. A representative example of a zeolitic-imidazolate-framework is ZIF-8 MOF.

The asymmetric mixed-metal membranes fabricated by the one-step method or process are used to separate fluid mixtures, for example, mixtures of gases and of liquids by flowing the mixture therethrough. The mixture of gases may be a mixture of at least two gases. A representative example is a binary gas mixture, for example, a mixture of C3 gases, such as a propylene/propane gas mixture. The mixture of liquids may be a mixture of at least two organic liquids and water.

The following examples are given for the purpose of illustrating various embodiments of the invention and are not meant to limit the present invention in any fashion.

### EXAMPLE 1

### Materials and Methods

### Materials

4,4-(Hexafluoroisopropylidene) diphthalic anhydride 2,4,6-trimethyl-1,3-phenylenediamine (6FDA-DAM) (Mw: 148k, PDI: 2.14) was purchased from Akron Polymer Systems Inc. 1-methyl-2-pyrrolidone (NMP, C5H9NO, >99.0%, Sigma-Aldrich), tetrahydrofuran (THF, C4H80, >99.0%, Alfa Aesar), methanol (MeOH, CH3OH, >99.8%, VWR International), ethanol (EtOH, C2H5OH, 94-96%, Alfa Aesar), zinc nitrate hexahydrate (ZnN, Zn(NO3)2.6H2O, 98%, Sigma-Aldrich), and 2-methylimidazole (Hmlm, C4H6N2, 99%, Sigma-Aldrich) were used. All chemicals were used as received without further purification.

### Synthesis of ZIF-8 Particles

Zn solutions of different concentrations were prepared by dissolving ZnN of 0.1 mmol, 0.3 mmol, and 0.6 mmol in 0.5 ml DI water. Likewise, ligand solutions of different concentrations were prepared by dissolving Hmlm of 5 mmol, 10 mmol, and 20 mmol in 10 ml DI water. A Zn solution was dropped into a ligand solution. Immediately, the mixture solution turned white and the reaction proceeded for 5 min at room temperature. Precipitates were collected by centrifuging the suspension for 10 min. Afterward, the precipitates were washed with MeOH and centrifuged for 15 min. The acquired samples were dried at 60° C. overnight.

### Fabrication of Polymer and Mixed-Matrix Membranes

A polymer solution was prepared by dissolving 15 wt % of 6FDA-DAM in 40.7 w % NMP and 20.3 wt % THF, followed by addition of non-solvent additives of 6 wt % ZnN and 18 wt % EtOH. The solution was shaken on a lab shaker overnight at room temperature until it became homogeneous. The homogenous polymer solution was then casted with thickness of ˜470 μm on a polypropylene (PP) filter (Whatman, 7002-0290) at room temperature using a casting knife. The casted nascent polymer film was immersed immediately into an aqueous coagulation bath containing Hmlm with varying concentrations (0.0 M, 0.5 M, 1.0 M, 1.5 M, and 2.0 M) in 150 ml DI water. The resulting membrane sample was kept into the coagulation bath for 1 hr and moved to a MeOH solution for solvent exchange. After 1 hr in the MeOH solution, the sample was slowly dried under a nearly saturated environment with MeOH for 48 hrs. The resulting membrane was measured at ca. 130±10 μm in thickness and stored in a petri dish for characterization and testing. For a comparison purpose, a conventional MMM with ca. 20 wt % ZIF-8 loading was prepared using a priming and blending method. ZIF-8 particles were prepared by following a procedure described elsewhere (1). A ZIF-8/solvent suspension was prepared by dispersing the ZIF-8 particles in THF in a sonication bath. Afterward, a small amount of 6FDA-DAM (10 wt % of the total polymer in MMMs) was added into the ZIF-8 suspension and stirred for 6 hours. The remaining polymer was added into the suspension and further stirred overnight on a lab shaker. Once the mixture solution became homogeneous, it was casted on a glass plate and covered with aluminum foil. The solvent was slowly evaporated at room temperature for 2 days. The membrane was determined ca. 280 μm thick.

### Characterization

Scanning electron microscope (SEM) images were taken using a JEOL JSM-7500F at acceleration voltage of 5 keV and working distance of 15 mm. Transmission electron microscopy (TEM) analysis was conducted using a FEI Tecnai G2 F20 Super-Twin FE-TEM operating at 120 keV. TEM samples were prepared using a Tescan LYRA-3 Model GMH dual-beam FIB instrument. X-ray diffraction (XRD) patterns were collected using a Miniflex II diffractometer (Rigaku) with Cu-Kα radiation (λ=1.5406 Å) in the 2θ range of 5-40 o. A Nicolet iS5 spectrophotometer equipped with iD7 ATR (Thermo Scientific) was used to obtain attenuated total reflectance Fourier transform infrared (ATR-FTIR) spectra at a resolution of 5 cm-1 with 16 scans in the span of 4000-400 cm-1. Thermogravimetric analysis (TGA) was performed using Q50 (TA instruments) in the temperature range of 25° C. to 800° C. at the heating rate of 10° C. min-1 under air flow of 60 cm3 min-1. N2 adsorption isotherms were taken using ASAP 2020 plus (Micromeritics) at 77 K

### Gas Permeation Measurement

An equimolar binary propylene/propane separation performance of the membranes were performed using the Wicke-Kallenbach technique at room temperature under atmospheric pressure. A feed gas mixture was provided at the total flow rate of 100 cm3 min-1. Argon sweeping gas was flowed onto the permeate side at the same flow rate of the feed gas. A membrane was placed in a custom-made permeation cell and sealed with rubber rings. The composition of the permeate was detected using a gas chromatography (GC 7890A, Agilent) equipped with a flame ionized detector (FID) and a HP-plot Q column.

### EXAMPLE 2

### Symmetric MMM Membrane Preparation via the PIMOF Process

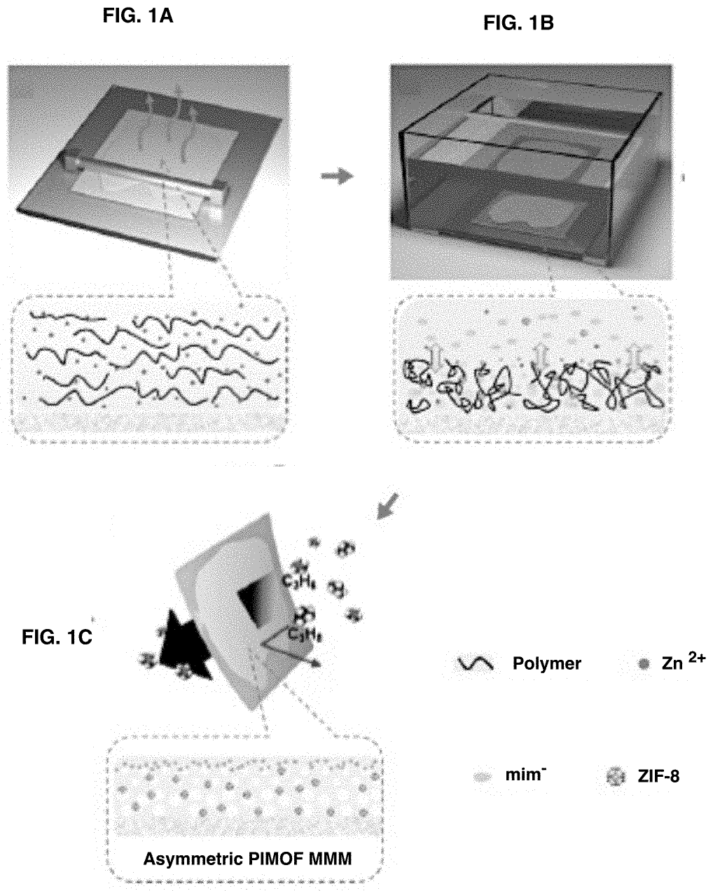

The proposed novel MMM fabrication strategy, phase-inversion in sync with metal-organic framework formation (PIMOF), is based on the in-situ formation of ZIF-8 nanoparticles concurring with the formation of an asymmetric polymer film by phase inversion. It is noted that the phase inversion technique has been widely used to prepare commercial asymmetric polymer membranes (both flat and hollow fibers) (13, 14). FIGS. 1A-1C illustrate how an asymmetric MMM is prepared using the PIMOF process. First, a zinc-containing polymer solution is prepared by adding a proper amount of a zinc source to a 6FDA-DAM solution (FIG. 1A). The zinc-containing polymer solution is then casted on a porous polymeric support with a casting knife. Volatile components are partially evaporated for a short time, making the top layer more concentrated with polymer than the bottom layer, which eventually facilitates the formation of an asymmetric membrane (i.e., a skin layer on top of a bottom porous layer) (FIG. 1A).

As the casted nascent polymer film is immersed into a coagulation bath containing Hmlm ligands, phase inversion is induced by liquid-liquid demixing (FIG. 1B). As shown in the bottom illustration of FIG. 1B, the solvent in the nascent polymer film is replaced by an infusion of the non-solvent in the coagulation bath, which leads to the solidification of the polymer film by polymer chain entanglement and thereby to the formation of an asymmetric structure (15). In sync with the polymer phase-inversion, the zinc ions in the polymer film and the Hmlm in the coagulation bath diffuse in the opposite direction (i.e., counter-diffusion), thereby enabling the in-situ formation of ZIF-8 filler particles inside the polymer film (FIG. 1B, bottom). The diffusion of the ligands into the polymer is much faster than that of the zinc ions into the coagulation bath since the ligands diffuse along with the non-solvent invading into the polymer film. This results in the formation of ZIF-8 particles mostly inside the polymer film. The resulting 6FDA-DAM/ZIF-8 MMM exhibits an asymmetric structure with a selective dense mixed-matrix top layer on a porous bottom layer (FIG. 1C, bottom). The PIMOF process is highly scalable since it resembles commercially adopted and widely used phase-inversion processes in commercial polymer membrane manufacturing (16).

### EXAMPLE 3

### Polymer Solution Composition for Asymmetric Membrane Formation

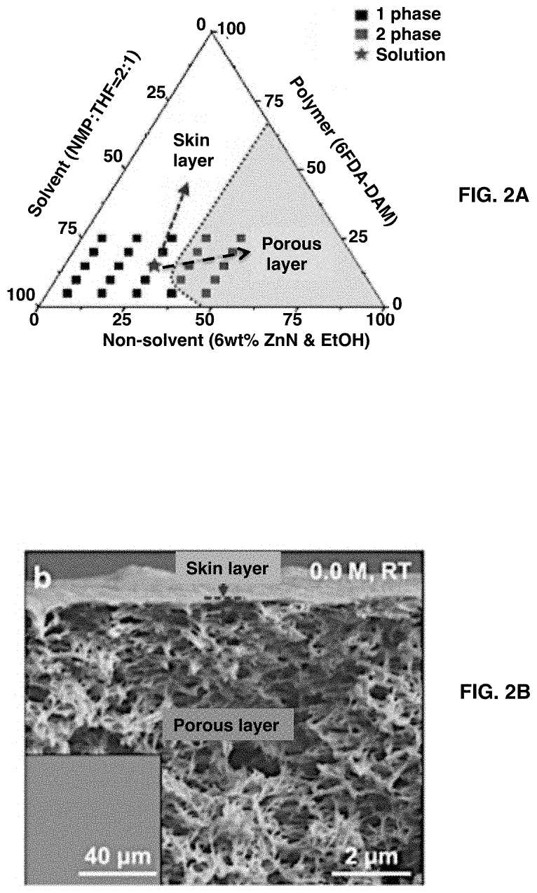

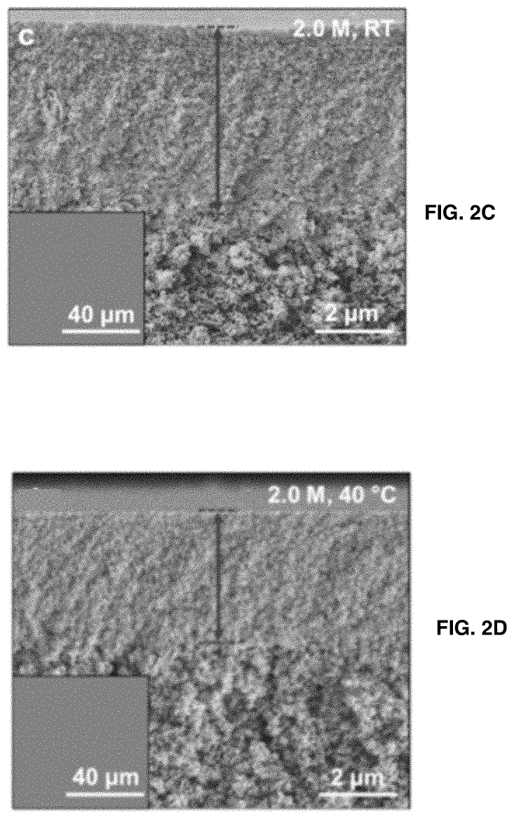

The composition of the polymer solution is of critical importance in order to obtain a defect-free dense skin layer on top of a porous layer in an asymmetric membrane (15, 17). Since the polymer solution must be in a single phase, the ternary polymer/solvent/non-solvent system was carefully investigated by varying the composition of the solution, thereby determining a ternary phase diagram. As shown in the phase diagram (FIG. 2A), the polymer concentration was set at 15 wt % exhibiting a proper viscosity (18). If the concentration is too high, the solution becomes too viscous, consequently difficult to process. An allotted amount of 6FDA-DAM polymer was dissolved in two miscible solvents, non-volatile NMP and volatile THF, with 2:1 ratio by weight (19, 20). Since ZnN serves as a non-solvent additive, the maximum ZnN loading in the polymer/solvent system was 8 wt %. In other words, too much ZnN led to undesirable phase separation. As such, the concentration of ZnN was fixed at 6 wt % (FIG. 2A). Once casted, the volatile solvent and non-solvent (i.e., THF and EtOH, respectively) evaporate from the casted nascent polymer film, leading to the relatively high polymer concentration in the top layer, which then evolves in the single-phase region in the coagulation bath (FIG. 2A, skin layer arrow). On the other hand, the composition of the bottom layer is such that it goes through phase separation in the coagulation bath (FIG. 2A, porous layer arrow). This separate evolution of the top and bottom layers of the nascent polymer film is critical to form a defect-free skin layer on top of a porous layer (FIG. 2A) (15).

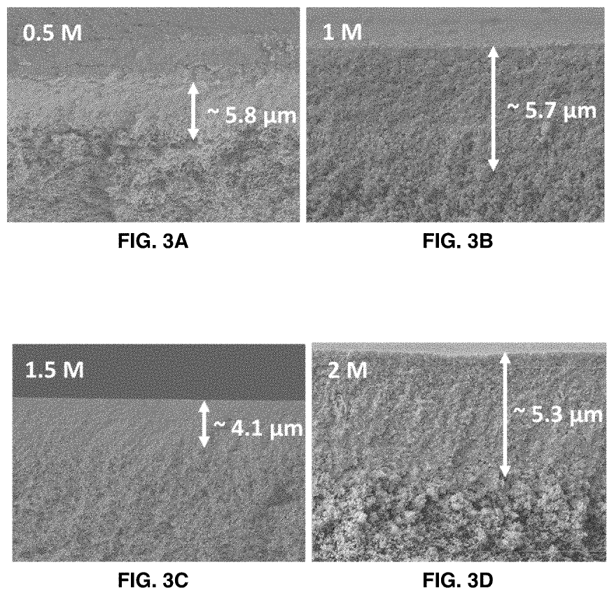

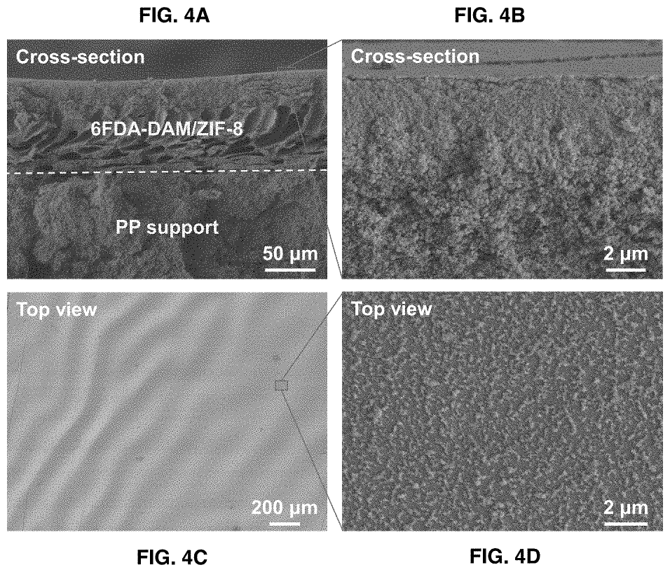

Due to the counter diffusion of zinc ions in the polymer solution film and Hmlm in the coagulation bath, ZIF-8 filler particles form in-situ inside the polymer film in sync with polymer phase-inversion. FIGS. 2B-2D show the electron micrographs of a 6FDA-DAM membrane without Hmlm in the coagulation bath and 6FDA-DAM/ZIF-8 MMMs by the PIMOF process (hereafter, PIMOF MMMs) with various Hmlm concentrations (2.0 M) in the coagulation bath at RT. The coagulation bath temperature was fixed at RT. Several observations can be made. First, both polymer membrane and MMMs show asymmetric structures. While the polymer membrane displays a submicron thick skin layer, several micron thick skin layers were observed for the PIMOF MMMs (FIGS. 2B and 3A-3D). As the Hmlm concentration in the coagulation bath increases, the thickness of the skin layer keeps at ca. 4-6 μm (FIGS. 2B and 3A-3D). The top of the SEM images (FIGS. 2B-2D, insets) show no macroscopic pinhole defects. On the other hand, when the coagulation bath temperature was raised from RT to 40° C., the diffusion of the non-solvent was promoted, thereby enhancing phase inversion (21) and consequently reducing the thickness of the apparent skin layer (FIG. 2D). When the bath temperature was further raised to 60° C., however, the porous layer was partially collapsed and undesirable pinholes on the skin layer were formed (FIGS. 4A-4D) (22, 23).

### EXAMPLE 4

Formation of ZIF-8 Particles Inside the Polymer in Sync with Polymer Phase Inversion

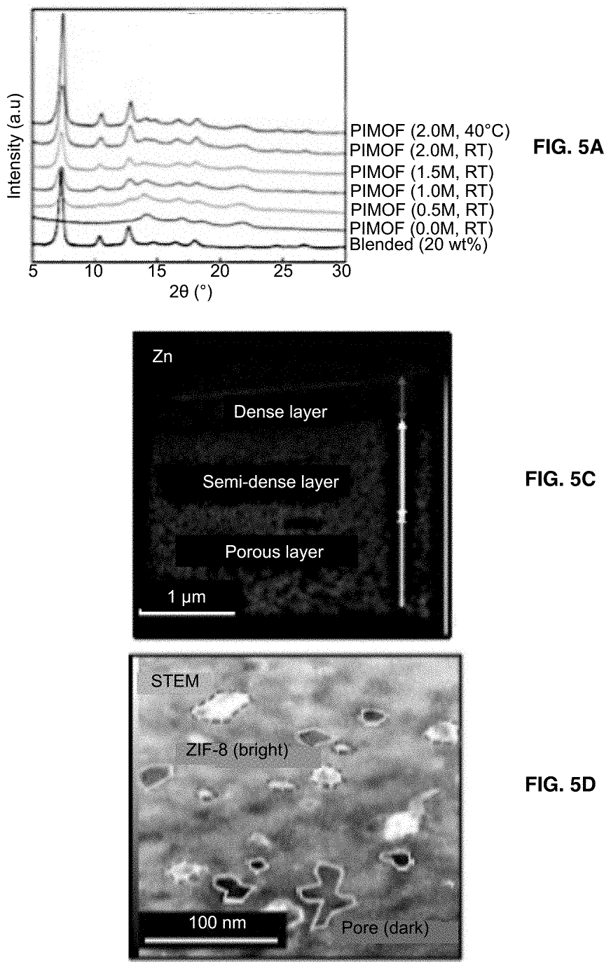

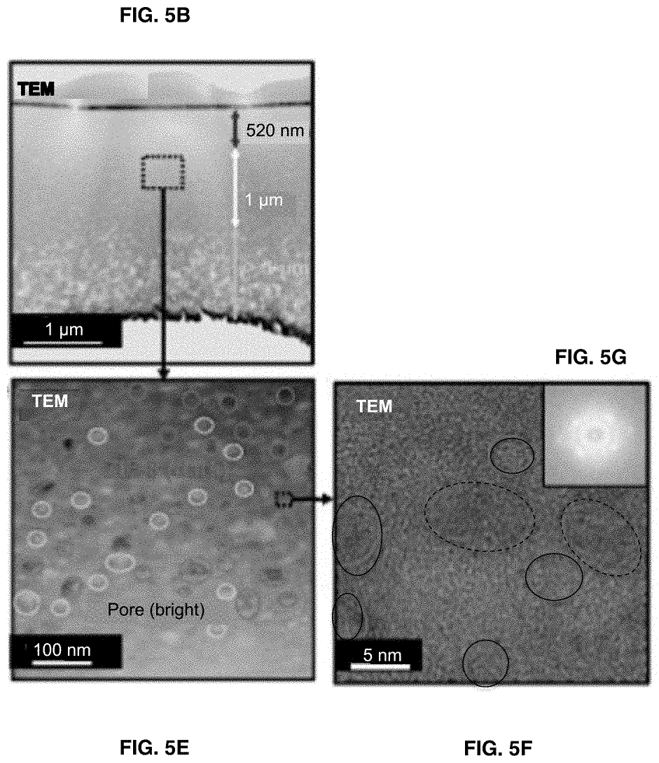

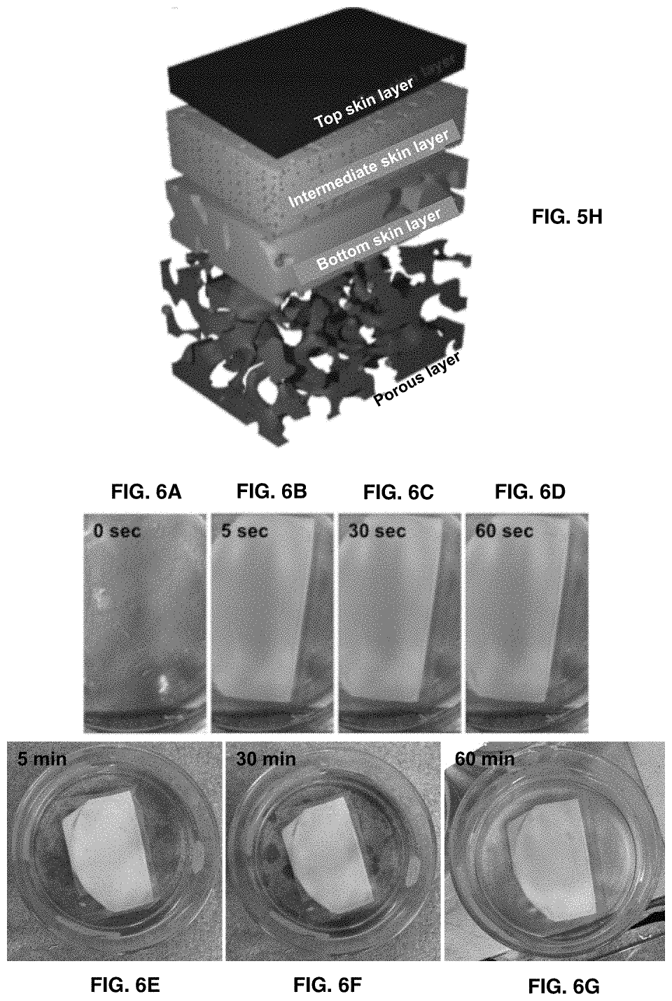

FIG. 5A shows the XRD patterns of the PIMOF MMMs prepared with varying linker concentrations and temperatures of coagulation baths. The diffraction patterns of the PIMOF MMMs were consistent with that of ZIF-8, confirming the in-situ formation of ZIF-8 filler particles inside the polymer in sync with polymer phase inversion (FIG. 5A). It is worthy of noting that the ZIF-8 fillers were mostly formed inside the polymer films rather than on the membrane surface (FIGS. 2B-2D, insets and FIGS. 6A-6G). Furthermore, there were few ZIF-8 particles found in the coagulation bath (FIGS. 6A-6G). This is likely because the diffusion of Hmlm into the polymer is much faster than that of zinc ions into the coagulation solution due to 1) the diffusion of the charged zinc ions requires charge-balancing anions and 2) the diffusion of Hmlm can be assisted by the infusion of the non-solvent into the polymer.

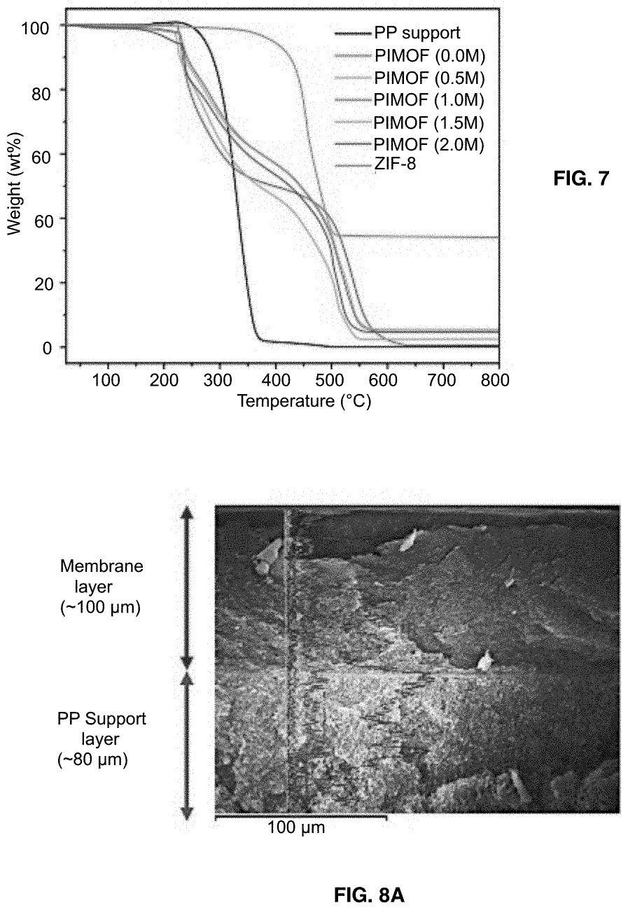

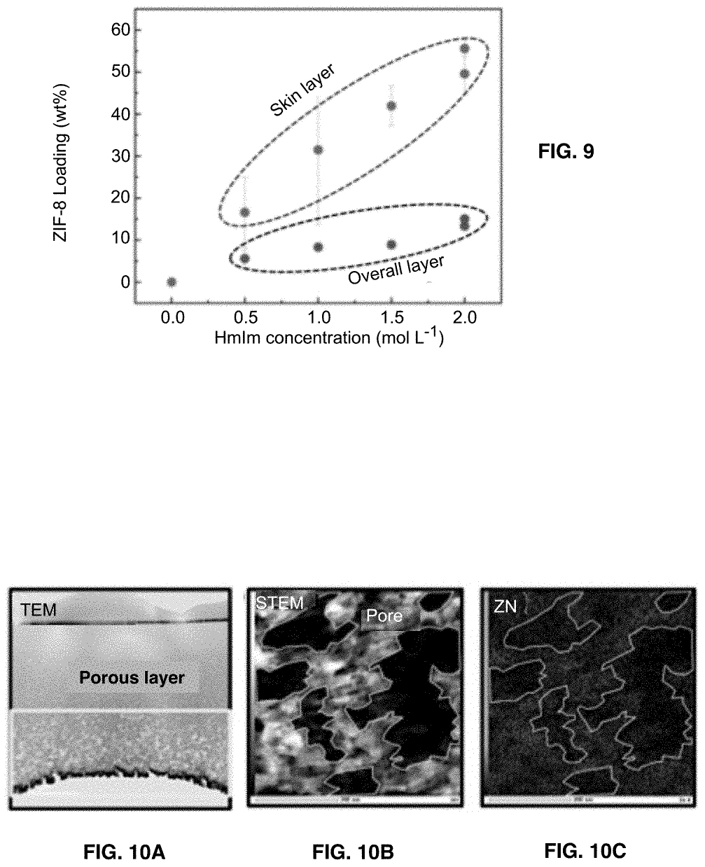

The overall amounts of ZIF-8 fillers in the PIMOF MMMs were determined using thermal gravimetric analysis (TGA) (FIGS. 7 and 9). As the Hmlm concentration in the coagulation bath increased from 0.0 M to 0.5 M, 1.0 M, 1.5 M, and 2.0 M, the total ZIF-8 loadings in the PIMOF MMMs increased linearly (FIG. 9), which is consistent with the XRD observation (FIG. 5A). Table 1 compares Hmlm concentration to ZIF-8 loading at the top 5 μm layer.

TABLE 1
HmIm concentration as affecting ZIF-8 loading

| HmIm | | | |
|---|---|---|---|
| concentration | Temperature | Total ZIF-8 | ZIF-8 loading at a top 5 |
| (M) | (° C.) | loading (wt %) | um layer (wt %) |
| 0.5 | RT | 5.59 ± 2.17 | 16.62 ± 8.28 |
| 1 | RT | 8.32 ± 0.35 | 31.47 ± 17.81 |
| 1.5 | RT | 8.91 ± 0.96 | 41.94 ± 4.69 |
| 2 | RT | 13.30 ± 0.50 | 49.56 ± 4.94 |
| 2 | 40 | 15.06 ± 0.53 | 55.60 ± 1.99 |

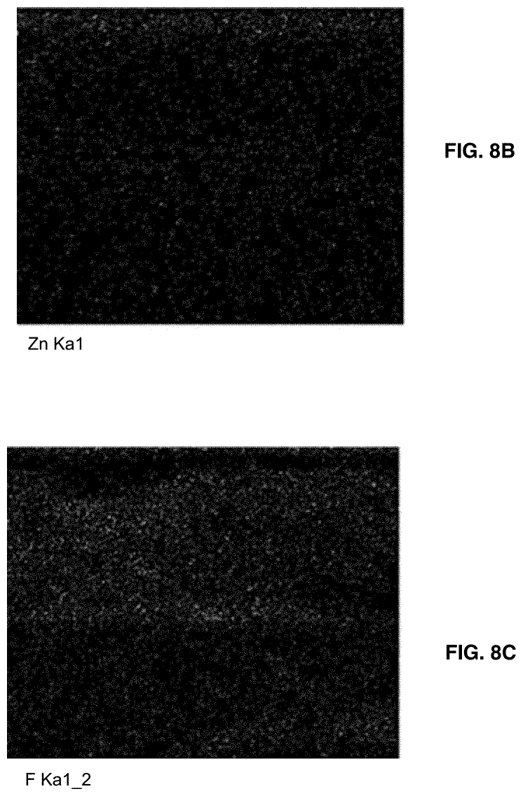

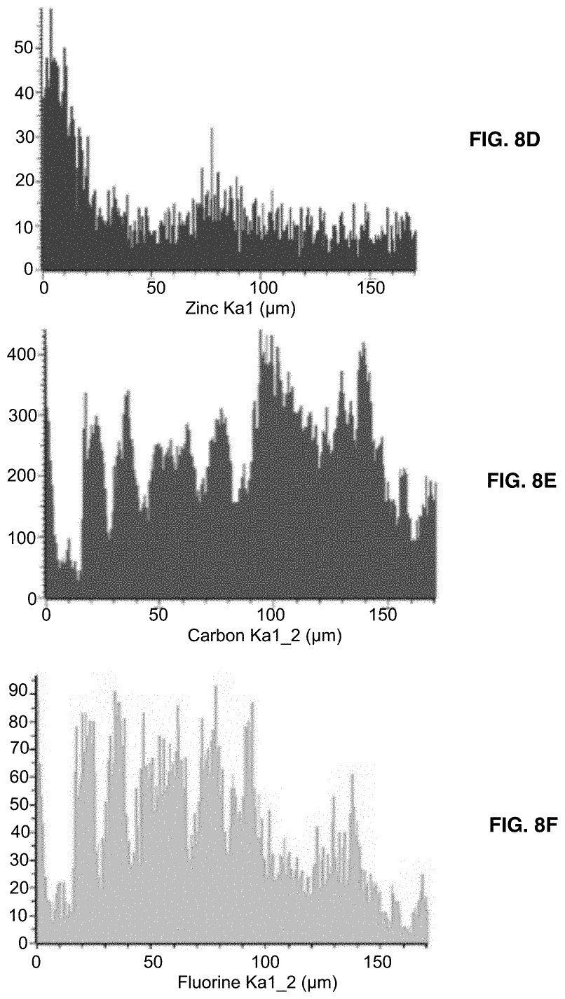

The highest total ZIF-8 loading was estimated ca. 15 wt %, which was achieved at 2.0 M of the linker concentration and 40° C. of the bath temperature. It is noted that the total ZIF-8 loading includes filler particles formed in the skin layer as well as those in the bottom porous layer. As shown in FIGS. 8A-8F and 9, the EDS mapping of the PIMOF MMMs clearly revealed relatively strong Zn signals at the top layer of ca. 5 μm, strongly suggesting the higher ZIF-8 loadings in the top layer than in the porous bottom layer. Using the TGA analysis combined with the EDS elemental analysis, the average ZIF-8 loadings in the top ca. 5 μm layers were estimated as high as ca. 55.6 wt %, much higher than the total ZIF-8 loading.

To investigate the microstructure of the ZIF-8-containing skin layers, TEM and STEM analyses were performed on the PIMOF MMM prepared in a coagulation bath containing 2.0 M of Hmlm at 40° C. (hereafter, PIMOF MMM (2.0 M, 40° C.). FIG. 5B presents the TEM image of the top ca. 3 μm thick skin layer of the membrane. The image reveals the presence of three distinct layers within the skin layers: 1) a top skin layer of ca. 520 nm in thickness, 2) a ca. 1 μm thick intermediate skin layer, and 3) a bottom skin layer. The top skin layer appears to be dense with little zinc signals in the TEM-EDS mapping (FIG. 5C), indicating no ZIF-8 fillers formed in this layer. This is likely due to the fact that the zinc ions trapped in the top skin layer were mostly washed out before forming ZIF-8 filler particles due to the shorter diffusion length during phase inversion (i.e., the diffusion time scale is shorter than the reaction time scale). FIGS. 5D-5E presents a STEM image and a TEM image of regions in the intermediate skin layer between the top skin layer and the bottom skin layer.

As can be seen in the figures, there are many bright and dark spots in the STEM and the TEM images, respectively, uniform in size of ca. 5 nm, which are assigned most likely to ZIF-8 filler nanoparticles. In addition, one can observe even brighter (STEM) and darker (TEM) spots irregular in size that are larger than the nanosized spots. FIG. 5F presents a TEM image of one such darker spot that shows particles consisting of a few coalesced nanocrystals of <ca. 5 nm in size (see red dotted closed contours in the figure). The corresponding fast Fourier transform (FFT) confirms the dark spots enclosed in red lines in FIG. 5E are ZIF-8 nanocrystals and their coalesced particles. It is noted that the typical MOF/ZIF filler particle sizes for MMMs are in the range of ca. 20-100 nm (24). As such, the filler size of <ca. 5 nm is unprecedented for MMMs. FIG. 5E also shows dark (STEM) and bright (TEM) regions of ca. 10˜20 nm that are irregular in size and shape, which correspond to mesopores. The pores are much smaller in size than the thickness of the intermediate skin layer and are relatively sparsely dispersed in the layer. Judging from these observations, the pores in the intermediate skin layer seem not likely connected with each other (i.e., isolated dead-end pores). In other words, the pores in the intermediate skin layer are not likely short-circuiting gas transport, rather effectively enhancing gas transport. On the other hand, the bottom skin layer shows a lot more pores that are much bigger and more importantly interconnected (FIG. 10A-10C).

### EXAMPLE 5

### PIMOF MMM: N₂ Adsorption

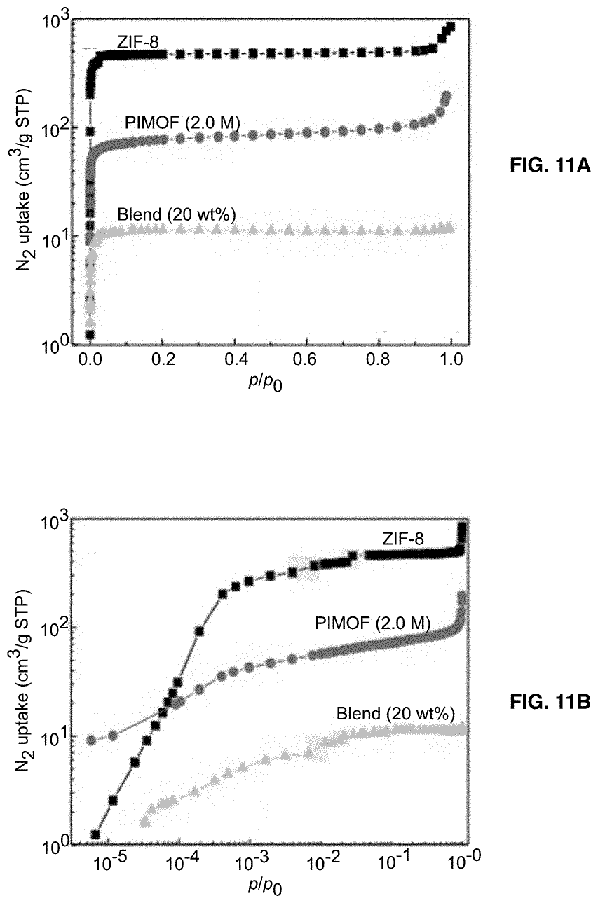

FIGS. 11A-11B presents the N₂ adsorption isotherm of the PIMOF MMM (2.0 M, RT) in comparison with those of ZIF-8 powder and a ZIF-8-containing MMM prepared by a conventional blending method (hereafter, blended MMM). A couple of observations can be made. First, as shown in FIG. 11A, the pore volume of the PIMOF MMM is much smaller than that of the ZIF-8 powder due to the non-porous polymer phase in the PIMOF MMM (note that the specific uptake is presented in a log-log scale). Meanwhile, the PIMOF MMM exhibits significantly larger pore volume than the blended MMM despite its lower total ZIF-8 loading (12 wt % vs 20 wt %). This can be attributed to the much shorter diffusion length of the PIMOF MMM since it is asymmetric with a much thinner skin layer which is the combination of the top dense layer, the intermediate semi-porous layer and the bottom porous layer (ca. 5 μm) than the blended MMM (ca. 280 μm). Second, as can be seen in FIG. 11B, the ZIF-8 powder and the blended MMM clearly show typical two-step gate-opening phenomena at the relative pressures of ca. 0.004/ca. 0.02 and ca. 0.007/ca. 0.02, respectively (FIG. 11B, dotted rectangles) (25). In a stark contrast, the PIMOF MMM exhibits no apparent gate opening possibly due to the restricted swing motion of the mlm linkers resulting from relatively strong interaction with polymer chains. Another interesting observation is that at low relative pressures (p/p₀<10⁻⁴), the PIMOF MMM exhibits much higher gas uptake, strongly suggesting that it possesses more high-energy adsorption sites. The presence of these high-energy adsorption sites might be due to the unprecedentedly small sub-5nm ZIF-8 filler nanoparticles with much greater surface-to-volume ratio. These high-energy surfaces of the ZIF-8 nanofillers are expected to result in the much stronger interaction between the fillers and the polymer than typical ZIF-8 filler particles, thereby considerably affecting the swing motion of the linkers and consequently the molecular sieving properties of the ZIF-8 nanofillers (26).

### EXAMPLE 6

### PIMOF MMM: Binary Propylene/Propane Separation Performance

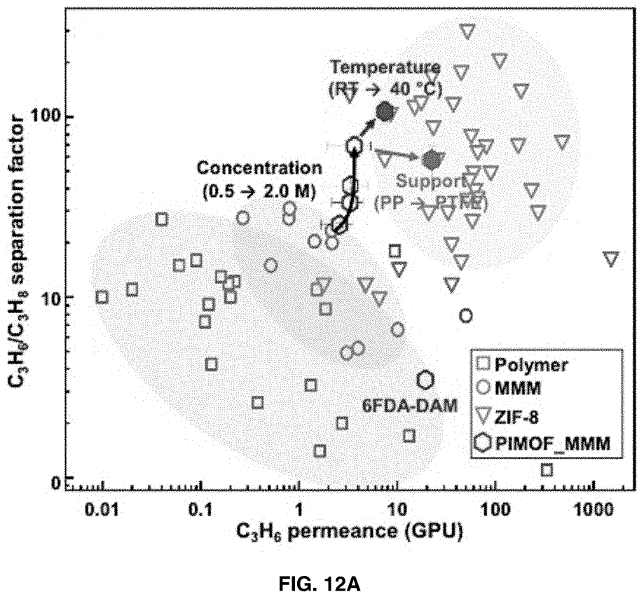

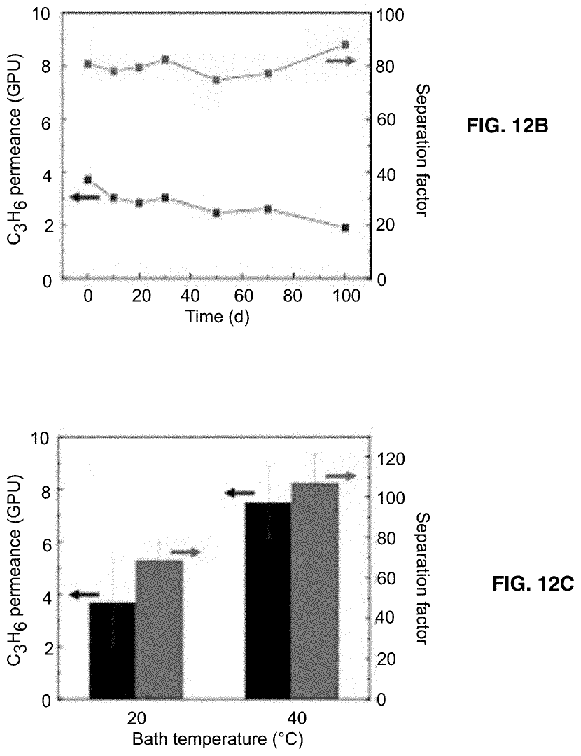

FIG. 12A and Table 2 present the binary propylene/propane (C3) separation performances of the PIMOF MMMs in comparison with other membranes including MMMs prepared by a conventional blending method and the PMMOF (27). The C3 separation performances of the PIMOF MMMs were considerably affected by the processing conditions such as linker concentration and phase inversion temperature. As the Hmlm concentration in the coagulation bath increased, both the C₃H₆ permeance and the separation factor of the PIMOF MMMs increased due to the increased ZIF-8 loading (FIG. 12A and Table 2).

TABLE 2
Summary of C3 separation performances of PIMOF MMMs measured
using equimolar C3 gas mixture at ~1 atm and RT

| Coagulation bath | | | | |
|---|---|---|---|---|
| condition | | | | |
| HmIm | | C₃H₆ | C₃H₈ | C3 |
| (mol | Temperature | permeance | permeance | separation |
| L⁻¹) | (° C.) | (GPU) | (GPU) | factor |
| 0.0 | RT | 19.36 ± 4.07 | 5.57 ± 1.71 | 3.48 ± 0.34 |
| 0.5 | RT | 2.59 ± 0.92 | 0.10 ± 0.04 | 25.20 ± 0.74 |
| 1.0 | RT | 3.32 ± 1.17 | 0.10 ± 0.03 | 33.44 ± 3.24 |
| 1.5 | RT | 3.34 ± 1.63 | 0.08 ± 0.04 | 41.47 ± 0.90 |
| 2.0 | RT | 3.68 ± 1.73 | 0.05 ± 0.02 | 68.72 ± 8.93 |
| 2.0 | 40 | 7.48 ± 1.39 | 0.07 ± 0.004 | 106.93 ± 14.42 |

The increase in the C₃H₆ permeance was somewhat modest as compared to that in the separation factor, which was attributed to the similar thickness of the skin layer (SEM images in FIGS. 2C and 3A-3D). At the Hmlm concentration of 2.0 M, the PIMOF MMMs (2 M, RT) show surprisingly high C3 separation performances with the C₃H₆ permeance of 3.68±1.73 GPU and the average C3 separation factor of 68.72±8.93. It is noted that the conventionally-prepared ZIF-8-containing MMMs showed C₃H₆/C₃H₈ (C3) separation factors as high as ca. 31.1 (28) while the MMMs by the PMMOF exhibited C3 separation factors of ca. 38.04 (11). The C₃H₆ permeabilities are not reported because it was difficult to precisely determine the thickness of the active separation layer (i.e., intermediate skin layer) due to the ambiguous boundary between the intermediate skin layer and the bottom skin layer (22).

When the coagulation bath temperature was raised to 40° C., the resulting PIMOF MMMs showed the dramatically enhanced C3 separation performance (FIG. 12C). The PIMOF MMMs (2.0 M, 40° C.) show unprecedentedly high C3 separation performances with the C₃H₆ permeance of 7.48±1.39 GPU and the average C3 separation factor of 106.93±14.42, respectively. The faster phase inversion rate at the higher temperature resulted in forming a thinner apparent skin layer (FIGS. 2C-2D), consequently increasing the C₃H₆ permeance. Furthermore, the higher temperature accelerated the in-situ formation of ZIF-8 filler nanoparticles, thereby increasing the ZIF-8 loading in the skin layer (>50% at 40° C. vs >40 wt % at RT). It is reminded that when the coagulation bath temperature was further raised to 60° C., the resulting membranes showed pinholes as well as many particles formed on the membrane surface (FIGS. 4A-4D), resulting in poor separation performances.

As shown in FIG. 12A, the C3 separation performances of the PIMOF MMMs are comparable even with some of the best-performing polycrystalline ZIF-8 membranes (29-39). The unexpectedly high C3 separation performances of the PIMOF MMMs are ascribed likely to 1) the uniform distribution of the extremely small ZIF-8 nanoparticles (<5 nm), 2) the high ZIF-8 loadings in the intermediate layers (>50 wt %), and 3) the enhanced molecular sieving property of the ZIF-8 nanofillers resulting from the restricted linker swing motion. In addition, the PIMOF MMMs show stable separation performances over several months (FIG. 12B). Changing the polymeric support from polypropylene (PP) to polytetrafluoroethylene (PTFE) increased the C₃H₆ permeance significantly from 3.68±1.73 GPU to 14.32±3.80 GPU while maintaining relatively high C3 separation factor (64.08±10.59) (FIG. 12A).

The following references are cited herein.
1. Koros, W. J., Macromolecular Symposia, 188(1):13-22, 2002.
2. Sholl, D. S. and R. P. Lively, Seven chemical separations to change the world. Nature, 532(7600):435-437, 2016.
3. Baker, R. W., Industrial & Engineering Chemistry Research, 2002. 41(6): p. 1393-1411.
4. Robeson, L. M. Journal of Membrane Science, 2008. 320(1): p. 390-400.
5. Valappil et al. Journal of Industrial and Engineering Chemistry, 2021. 98: p. 103-129.
6. Hamid, M. R. A. and H. K. Jeong, Korean Journal of Chemical Engineering, 2018. 35(8): p. 1577-1600.
7. Yehia et al. In Abstracts of Papers of the American Chemical Society. 2004. Amer Chemical Soc, 1155 16^{th} St., NW, Washington, D.C. 20036 USA.
8. Galizia et al. Macromolecules, 50(20):7809-7843, 2017.
9. Jiang et al. ACS Applied Materials & Interfaces, 10(29):24784-24790, 2018.
11. Park et al. Acs Applied Materials & Interfaces, 11(29):25949-25957, 2019.
12. Park, S. and H.-K. Jeong, Journal of Membrane Science, 612:118429, 2020.
13. Sukitpaneenit, P. and T.-S. Chung, Chapter 16—Molecular elucidation of morphology and mechanical properties of PVDF hollow fiber membranes from aspects of phase inversion, crystallization, and rheology, in Hollow Fiber Membranes, T.-S. Chung and Y. Feng, Editors. 2021, Elsevier. p. 333-360.
14. Pinnau, I. and W. J. Koros, Journal of Applied Polymer Science, 43(8):1491-1502, 1991.
15. Wijmans et al. Polymer, 26(10):1539-1545, 1985.
16. Feng et al. Separation and Purification Technology, 111:43-71, 2013.
17. Shieh, J.-J. and T.S. Chung, Journal of Membrane Science, 140(1):67-79, 1998.
18. Hosseini et al. Journal of Membrane Science, 349(1-2):156-166, 2010.
19. Chen et al. Journal of Membrane Science, 382(1-2): p. 212-221, 2011.
20. Dong et al. Journal of Membrane Science, 353(1-2): p. 17-27, 2010.
21. Jiang, L., Journal of Membrane Science, 240(1-2):91-103, 2004.
22. Zhang et al. AIChE Journal, 2014. 60(7):2625-2635, 2014.
23. Zhang et al. Journal of Membrane Science, 550:9-17, 2018.
24. Dong et al. Journal of Materials Chemistry A, 1(15):4610-4630, 2013.
25. Fairen-Jimenez et al. Journal of the American Chemical Society, 133(23):8900-8902, 2011.
26. Friebe et al. Acs Applied Materials & Interfaces, 9(14):12878-12885, 2017.
27. Park et al. ACS Applied Materials & Interfaces, 11(29):25949-25957, 2019.
28. Ma et al. ACS Applied Nano Materials, 1(7):3541-3547, 2018.
29. Huang et al. Chemical Communications, 49(87):10326, 2013.
30. Pan et al. Journal of Membrane Science, 493:88-96, 2015.
31. Ma et al. Science, 361(6406):1008-1011, 2018.
32. Wei et al. Advanced Functional Materials, 30(7):1907089, 2020.
33. Barankova et al. Angewandte Chemie International Edition, 56(11):2965-2968, 2017.
34. Shamsaei et al. ACS Applied Materials & Interfaces, 8(9):6236-6244, 2016.
35. Lee et al. Journal of Membrane Science, 2018. 559:28-34, 2018.
36. Brown et al Science, 345(6192):72-75, 2014.
37. Eum et al. Advanced Functional Materials, 26(28):5011-5018, 2016.
38. Kwon et al. Science Advances, 8(1):eabl6841.
39. Zhou et al. Science Advances, 4(10):eaau1393.

What is claimed is:

1. A one-step method for fabricating an asymmetric mixed-matrix membrane, comprising:
forming an asymmetric polymer film simultaneously with forming metal organic framework (MOF) filler particles therein.

2. The one-step method of claim 1, wherein forming the asymmetric polymer film comprises:
transforming a liquid polymer solution containing a metal precursor in the presence of a ligand precursor to a solid polymer film with an asymmetric structure via phase inversion.

3. The one-step method of claim 2, wherein forming the MOF filler particles comprises:
diffusing the ligand precursor into the polymer solution as it solidifies to react in situ with the metal precursor to form the MOF filler particles therein.

4. The one-step method of claim 3, wherein forming the MOF filler particles occurs at room temperature to less than 100° C.

5. The one-step method of claim 2, wherein the polymer in the liquid polymer solution is a polyimide polymer.

6. The one-step method of claim 2, wherein the metal precursor is a nitrate, acetate, nitride, or sulfate of the metal or a chloride salt solution of zinc, cobalt, magnesium, manganese, iron, nickel, copper, zirconium, or cadmium, or a combination thereof.

7. The one-step method of claim 2, wherein the ligand precursor is an organic linker.

8. The one-step method of claim 2, wherein the organic linker is imidazole, 2-methyl imidazole, 2-ethylimidazole, 2-nitroimidazole, benzimidazole, 6-nitrobenzimidazole, 1-hexyl-3-methylimidazolium or purine or a combination thereof.

9. The method of claim 2, wherein the MOF filler particles are zeolitic-imidazolate-framework filler particles.

10. An asymmetric mixed-matrix membrane fabricated by the method of claim 1.

11. The asymmetric mixed-matrix membrane of claim 10, comprising:
an asymmetric polymer film formed with a skin layer on top of a bottom porous layer and a plurality of zeolitic-imidazolate-framework (ZIF) filler particles dispersed within the polymer film.

12. The asymmetric mixed matrix membrane of claim 11, wherein the skin layer comprises a plurality of intermediate layers with a majority of the plurality of the zeolitic-imidazolate-framework filler particles dispersed therein.

13. The asymmetric mixed-matrix membrane of claim 12, wherein the majority of the zeolitic-imidazolate-framework filler particles comprise about 50 wt % of the skin layer.

14. The asymmetric mixed-matrix membrane of claim 11, wherein the zeolitic-imidazolate-framework filler particles are less than 5 nm to about 10 nm in size.

15. The asymmetric mixed-matrix membrane of claim 10 that is a 6FDA-DAM/ZIF-8 asymmetric mixed-matrix membrane.

16. A method for separating a mixture of gases or of liquids comprising flowing the mixture through the asymmetric mixed-matrix membrane of claim 9.

17. The method of claim 16, wherein the mixture of gases is a binary gas mixture.

18. The method of claim 17, wherein the binary gas mixture is a propylene/propane gas mixture.

19. The method of claim 16, wherein the mixture of liquids is a mixture of organic liquids or a mixture of at least one organic liquid and water.

20. An asymmetric mixed-matrix membrane fabrication process, comprising:
transforming, via phase inversion at room temperature to about 40° C., a metal precursor containing liquid polyimide solution into which an imidazole diffuses during solidification of the polyimide solution to an asymmetric polymer film simultaneously as the metal precursor reacts in situ with the imidazole to form metal-imidazolate framework filler particles therein.

21. The asymmetric mixed-matrix membrane fabrication process of claim 20, wherein the metal precursor is a zinc nitrate.

22. The asymmetric mixed-matrix membrane fabrication process of claim 20, wherein a 6FDA-DAM/ZIF-8 asymmetric mixed-matrix membrane is fabricated.
